(19) United States
(12) Patent Application Publication
(10) Pub. No.: US 2026/0244658 A1
(43) Pub. Date: Aug. 20, 2026

(54) CONVERSATIONAL MEMORY WITH LARGE LANGUAGE MODELS

(71) Applicant: Home Depot Product Authority, LLC, Atlanta, GA (US)

(72) Inventor: Tushar Pujara, Carrollton, TX (US)

(21) Appl. No.: 19/541,996

(22) Filed: Feb. 17, 2026

Related U.S. Application Data
(60) Provisional application No. 63/759,392, filed on Feb. 17, 2025.

(51) Int. Cl. G06F 16/3329; G06F 21/62; G06F 40/30

(52) U.S. Cl. CPC G06F 16/33295; G06F 21/6254; G06F 40/30

(57) ABSTRACT

A method includes receiving, via an electronic user interface, an input from a user, generating a vector representation of the user input, determining a user intent based on the vector representation, retrieving, from a conversational memory store, data respective of a conversational session based on the user intent, determining a user privacy setting associated with the retrieved data, anonymizing the retrieved data based on the user privacy setting, and generating a prompt to a large language model based on the user input and the anonymized data respective of the conversational session.

### CROSS-REFERENCE TO RELATED DISCLOSURE

This application claims the benefit of priority to U.S. provisional application No. 63/759,392, filed on Feb. 17, 2025, which is hereby incorporated by reference in its entirety.

### FIELD OF THE DISCLOSURE

The present disclosure generally relates to conversational memory for large language models (LLMs), including in conjunction with chatbots, search interfaces, and other LLM-backed portions of an electronic user interface.

### BRIEF DESCRIPTION OF THE DRAWINGS

FIG. 1 is a block diagram view of a system for providing LLM-based portions of a computing user interface.

FIG. 2 is a flow chart illustrating an example method of processing user input in a computing user interface.

FIG. 3 is a flow chart illustrating an example method of managing long-term memory and short-term memory in connection with LLM conversational memory.

FIG. 4 is a flow chart illustrating an example method of session and context management in connection with LLM conversational memory.

FIG. 5 is a flow chart illustrating an example method of user profile management in connection with LLM conversational memory.

FIG. 6 is a diagrammatic view of an example user computing environment.

### DETAILED DESCRIPTION

Large language models (LLMs) generally lack robust mechanisms for retaining and utilizing conversational memory effectively, resulting in interactions that feel incoherent, impersonal, and discontinuous. This limitation hinders their ability to deliver tailored, context-aware responses across multiple interactions, maintain consistency in long-term dialogues, particularly for use cases requiring extended context, such as customer support, efficiently manage, store, and retrieve user-specific conversational histories while addressing scalability and privacy concerns, and simulate human-like conversational behavior by dynamically recalling and integrating relevant past interactions.

A goal of implementing conversational memory in large language models (LLMs) is to enable more meaningful, coherent, and contextually aware interactions with users. By remembering past exchanges, the model can enhance personalization by tailoring responses based on user preferences, previous interactions, and long-term context. The model also can improve coherence by maintaining continuity across conversations by understanding and referencing prior exchanges. Still further, through the use of conversational memory, the model can reduce repetition by avoiding re-asking questions or providing redundant information, support complex use cases by facilitating use cases requiring extended context, such as customer support, guided shopping assistance etc., and simulate human-like interactions by mimicking human conversational behavior by recalling and integrating past interactions.

Despite advancements in LLM technology, conversational memory in LLMs faces several challenges. First, finite memory results in a finite context window. Transformer-based models have a limited token window, restricting the amount of context they can consider at once. As a result, long-term context is lost, and conversations spanning multiple sessions or large amounts of data are not fully retained. Second, some approaches to conversational memory are not efficiently scalable. Storing and retrieving extensive user-specific histories for millions of users is resource-intensive, and memory systems require efficient indexing, retrieval, and summarization mechanisms. Third, personalization of conversational memory raises unique challenges. Namely, retaining user data poses risks related to data security and regulatory compliance (e.g., GDPR, CCPA), and determining the level of detail to store (that is, the appropriate level of conversational granularity) without overwhelming or misrepresenting the conversation is important. Fourth, models sometimes retrieve irrelevant or outdated information from memory, and there are not yet sufficient mechanisms to validate or update stored knowledge. Fifth, models may misremember or overemphasize certain parts of the conversation, which may lead to biased or inaccurate responses.

To address the above challenges in LLM conversational memory, the present disclosure provides numerous features. First, systems and methods according to the present disclosure may include a hierarchical memory system, including short-term memory that stores the current conversation context within the model's token window, long-term memory that uses external databases to store summaries, key points, or entire conversations, and dynamic memory retrieval where relevant parts of long-term memory are retrieved dynamically based on user queries. Second, systems and methods according to the present disclosure may include summarization of past interactions to reduce storage and improve retrieval efficiency. Embeddings may be generated to encode conversation summaries for semantic searching. Third, systems and methods according to the present disclosure may include contextual retrieval models that employ retrieval-augmented generation (RAG) architectures where memory modules fetch relevant information during response generation and that integrate vector databases to store and query conversational embeddings. Fourth, systems and methods according to the present disclosure may include a privacy-first architecture, including anonymization and encryption for stored user data and tools for users to control what is stored and direct the deletion of stored data. Fifth, systems and methods according to the present disclosure may include fine-tuned memory models, where smaller models are fine-tuned on user-specific data for personalized interactions. Sixth, systems and methods according to the present disclosure may include adaptive memory mechanisms that adaptively decide what to store, prioritize, or forget based on context relevance. Attention mechanisms may be used to weigh recent interactions more heavily while retaining critical long-term details. Seventh, systems and methods according to the present disclosure may include a scalable infrastructure that leverages distributed storage systems for scalable memory management and uses caching and tiered storage to balance performance and cost.

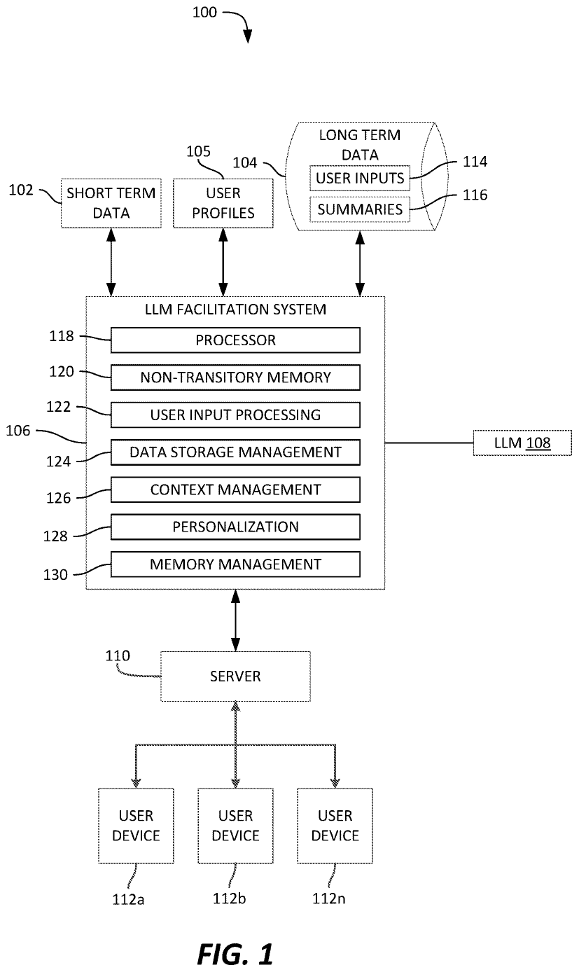

Referring to the drawings, wherein like reference numerals refer to the same or similar features in the various views, FIG. 1 is a block diagram view of a system 100 for operating a user interface, including LLM-based interactions for supporting the interface. The system 100 may include a store of short term data, a database (or other data store) of long term data 104, an LLM facilitation system 106, an LLM 108, and a server 110 in electronic communication with one or more user computing devices 112a, 112b, . . . 112n.

The server 110 may, in conjunction with the LLM facilitation system 106 and LLM 108, host or otherwise provide (e.g., support) a website, data for a mobile application, or other interface through which the users of the user computing devices 112 may navigate and otherwise interact with one or more documents respective of one or more items. As will be described below, users may provide input through the interface in various ways, which input may be analyzed by the LLM 108 for providing responsive information to the user in the interface. For example, the interface may include a chatbot, search query interface, and/or one or more additional portions in which a user may provide a sequence of inputs over one or more sessions. In some embodiments, the server 110 may receive user interactions through the interface and provide responsive content through the interface, including but not limited to content generated by the LLM 108.

In a first usage example, a user may, through a user device 112, submit one or more search queries in a search bar of the interface. A series of search queries submitted by the user, along with results reviewed and corresponding browsing, item selection, and other user interactions based on search results, may be considered a conversation. The context of the conversation and/or previous conversations may be utilized to aid the LLM in organizing search results, to enable the LLM to highlight or summarize aspects of the search results, for the LLM to generate further search queries, etc.

In a second usage example, a user may, through a user device 112, engage with a chatbot on the interface. The user's input to the chatbot, and the chatbot's responses, as well as user actions based on the chat (e.g., items selected based on chat recommendations), may be considered a conversation. The context of the conversation and/or previous conversations may be utilized to aid the LLM in providing informative and relevant responses to user input in the chat.

The LLM 108 may be or may include, for example, a META LLAMA large language model (LLM), an OPENAI GPT LLM, GOOGLE GEMINI LLM, or another large language model. The LLM 108 may be provided and accessed by the LLM facilitation system 106 on a service basis. Alternatively, the LLM 108 may be proprietary to the LLM facilitation system 106, and/or may be a dedicated private instance of the model. The LLM 108 may be trained on domain-specific information respective of the user interface hosted by the server 110, in some embodiments.

The short term data 102 may include data respective of a user's current session. In some embodiments, the short term data 102 may include server-side storage of data respective of each active user session. Additionally or alternatively, the short-term data 102 may be or may include client-side storage. The short-term data 102 may be stored in a cache or other storage medium with relatively fast read and write times.

The short-term data 102 may include complete text of user input and responsive information from the LLM facilitation system 106 in a current session. Additionally or alternatively, the short-term data 102 may include embeddings or other representations of individual user inputs, responsive information, and/or of the session itself, again for the current session, in some embodiments.

The long-term data 104 may include data respective of one or more (e.g., a plurality of) previous sessions. In some embodiments, the long-term data 104 may include server-side storage, such as a relational database and/or a NOSQL database, suitable for persistent, long-term data storage, search, and retrieval.

The long-term data 104 may include complete text of user input 114 and responsive information provided to users in previous sessions. Additionally or alternatively, the long-term data 104 may include embeddings or other representations of individual user inputs, responsive information, and/or one or more sessions, in some embodiments. In some embodiments, the long-term data 104 may store summaries 116 and/or representations of summaries of one or more previous sessions.

The LLM facilitation system 106 may include a processor 118 and a non-transitory, computer-readable memory 120 storing instructions that, when executed by the processor 118, cause the LLM facilitation system 106 to perform one or more of the methods, operations, algorithms, etc. described herein. The LLM facilitation system 106 may store a plurality of functional modules 122, 124, 126, 128, 130, which modules may be embodied as hardware and/or software. In some embodiments, the functional modules 122, 124, 126, 128, 130 may be embodied as instructions in the memory 120.

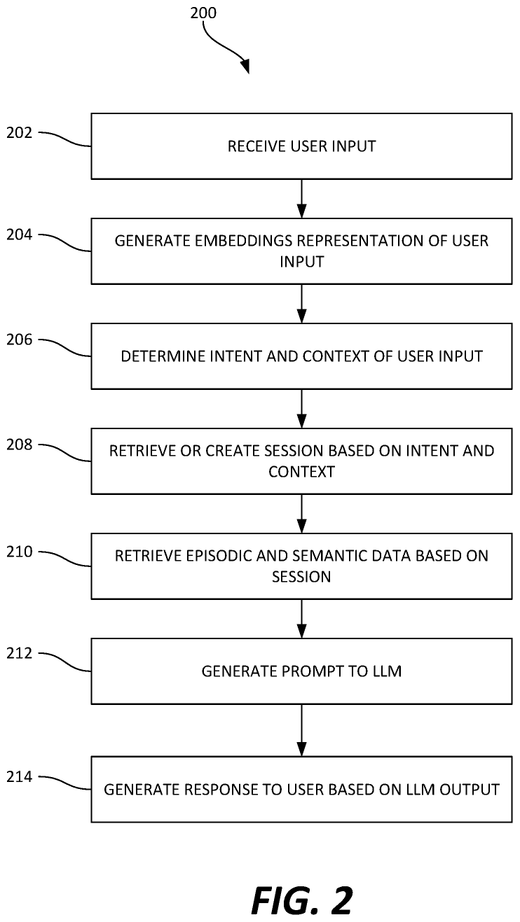

The LLM facilitation system 106 may include a user input processing module 122 that interprets a user input, facilitates the provision of the input and relevant associated data to the LLM 108, and provides responsive information from the LLM 108 to the user. Further detail on the operation of the user input processing module 122 is provided with respect to FIG. 2 below.

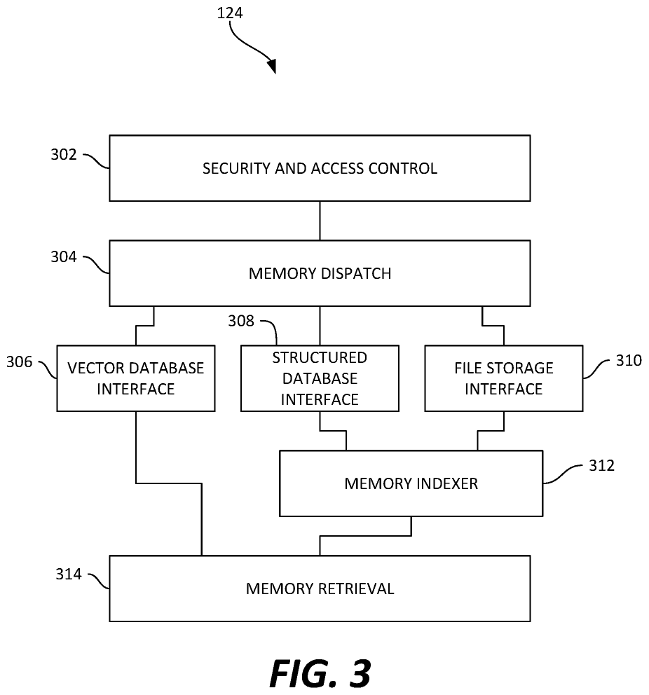

The LLM facilitation system may include a data storage management module 124 that facilitates user privacy management for data stored in the short term data 102 and the long term data 104, as well as searching and exchanging data with the short term data 102 and the long term data 104. Further detail on the operation of the data storage management module 124 is provided with respect to FIG. 3 below.

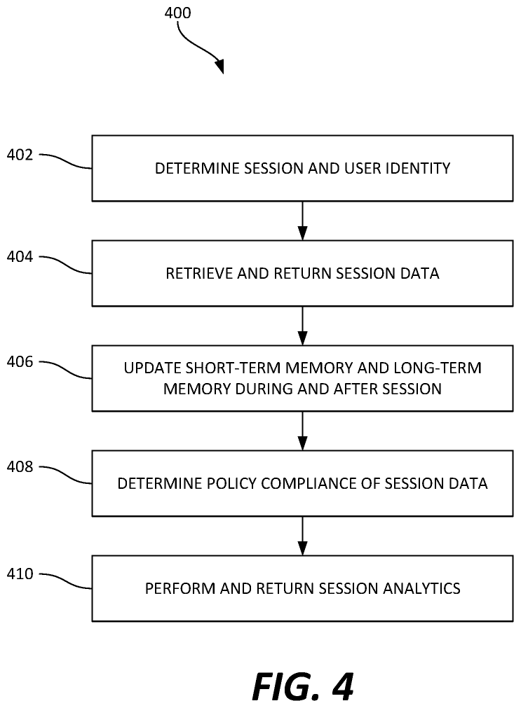

The LLM facilitation system may include a context management module 126 that establishes and maintains correspondence between data within a user session and across multiple user sessions, including the storage and recall of related data. Further detail on the operation of the context management module 126 is provided with respect to FIG. 4 below.

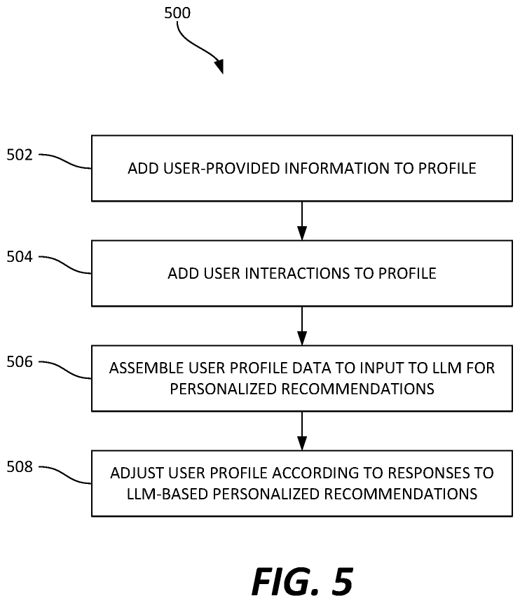

The LLM facilitation system 106 may include a personalization module 128 may update user profiles, recall relevant information from user profiles, and interact with the LLM 108 to generate profile-based responses to the user. Further detail on the operation of the personalization module 128 is provided with respect to FIG. 5 below.

The LLM facilitation system 106 may include a memory management module 130 that determines search and retrieval strategies for, and facilitating the use of, context data in the short term data 102 and the long term data 104, as described further below.

Functionality of the LLM facilitation system 106 will be described below with reference to the functional modules 122, 124, 126, 128, 130. It should be understood that disclosure in terms of modules is for ease of description. In various embodiments, functionality described with respect to a particular module may be embodied in one or multiple pieces of software and/or hardware. Similarly, functionality described with respect to multiple modules may be embodied in a single piece of software and/or hardware.

In operation, the LLM facilitation system 106 may receive input from a user via a user computing device 112 and may cause a relevant response to be regenerated and output to the user in response. To that end, the LLM facilitation system 106 may, with the user input processing module 122, determine an intent and context of the user input, as well as generate embeddings representations of user input. Further, the LLM facilitation system 106 may, via the context management module 126, retrieve information respective of the current session. Based on that intent, context, and session information, the LLM facilitation system 106 may, via the data storage management module 124 and memory management module 130, search the short-term data 102 and long-term data 104 for data relevant to the user's current input and, via the personalization module 128, search the user's profile for data relevant to the user's current input. Based on the data retrieved from short-term data 102, long-term data 104, and user profile data 105, the LLM facilitation system 106 may generate and input a prompt to the LLM 108. Alternatively, the user's input may be directly input to the LLM (e.g., with any private or confidential information having been removed by the LLM facilitation system 106 or otherwise), and the LLM facilitation system 106 may use the data retrieved from short-term data 102, long-term data 104, and user profile data 105 to interpret the LLM output and to generate a response to the user.

In addition to the real-time aspects of facilitating and mediating data exchange between a user and the LLM 108, the LLM facilitation system 106 may perform parallel and/or “offline” (i.e., at times unrelated to real-time exchange of data between the user and the LLM 108) functions including, for example, updates to user profiles 105, generating summaries 116 of the user's inputs, sessions, and the like, scanning and editing stored data to ensure policy compliance, and manage the storage of session data and other data.

FIG. 2 is a flow chart illustrating an example method of processing user input in a computing user interface. The method 200, or one or more aspects of the method 200, may be performed by the LLM facilitation system 106, and thus the method 200 may be computer-implemented.

The method 200 may include, at block 202, receiving a user input. As noted above, the user input may be a user query or other input to a chatbot, a user search query, and/or another user input that seeks responsive information. The user input may be received via a user interface, such as a website or mobile application.

The method 200 may further include, at block 204, generating an embeddings representation of the received user input. Block 204 may include, for example, application of an appropriate algorithm or model, such as Word2Vec, a transformer-based model such as BERT or RoBERTa, and the like. Block 204 may include, in embodiments, generating an embeddings vector of a single user input (e.g., a single search query, a single statement to a chatbot, etc.).

The method 200 may further include, at block 206, determining an intent and a context of the user input. Intent determination may be based on the content of the user's input and may include, for example, application of one or more techniques applied in PCT/US2023/075,983, entitled “Machine Learning-Based User Intent Determination,” and/or application of one or more techniques in U.S. application Ser. No. 18/239,791, entitled “Computer-Based Systems and Methods for Training and Using a Machine Learning Model for Improved Processing of User Queries Based on Inferred User Intent,” both of which applications are hereby incorporated by reference in their entireties.

Context determination at block 206 may include, for example, collection of metadata related to the user's input. For example, context data may include a time, day, date, month, season, location (e.g., IP address or known user location), submission channel of the input (mobile application, desktop computer, chatbot, search query, etc.), and the like.

Block 206 may further include, in some embodiments, extracting one or more entities from the user input. Entity extraction may include, for example, identifying each item or action in the user input. For example, the user input may be converted into a series of tokens (e.g., with each word in the input being a respective token, for example), and each token may be compared to a set of known entities. Tokens may be compared directly, or tokens may be converted into representations (e.g., embeddings vectors) and compared on a vector-to-vector basis. Extracted entities may be used for intent determination, as disclosed in the above-incorporated patent applications, as well as for session determination, as discussed below.

The method 200 may further include, at block 208, retrieving or creating a session based on the determined intent and context. Block 208 may include, for example, functionality of the context management module 126 described with respect to FIG. 3. In short, block 208 may include determining if the user input is part of an existing session. If it is, data respective of that existing session is used, as described below. If not, block 208 includes creating a new session.

The method 200 may further include, at block 210, retrieving episodic and semantic data based on the session information. For example, where block 208 includes determining that the user input is part of an existing session, block 210 may include retrieving data relevant to that session. In some embodiments, block 210 may include analyzing the determined user intent, the context of the user input, and session information (e.g., a session ID) to retrieve a summary of the session (e.g., in the form of an embeddings representation of the session to date), one or more prior user inputs or responses in the session, and other episodic information.

Block 210 may include retrieving semantic data, e.g., data respective of other sessions and/or data particular to the user that may be relevant to responding to the user input. For example, block 210 may include determining one or more data search strategies, such as searching for session summaries, user input, and relevant responses, with the same or similar user intent as the user intent determined at block 206. Block 210 may further include, in some embodiments, searching based on the context of the user input, or filtering search results for information obtained or output through the same or similar context. Block 210 may further include, in some embodiments, retrieving user profile information and searching or filtering search results based on that user profile information (e.g., for data involving similar users).

The method 200 may further include, at block 212, generating a prompt to the LLM. Generating the prompt may include, for example, generating an instruction for the LLM to generate a response to the user input, with one or more of the determined intent of the user input, the determined context of the user input, the retrieved episodic data, and/or the retrieved semantic data included in the prompt as data for analysis and consideration by the LLM to aid in preparation of a response. The inclusion of data respective of the current session and prior sessions enables the LLM to have appropriate background information for its responses, that is, to have improved conversational memory. Further, as will be described with respect to FIG. 4, summaries of sessions may be stored efficiently, and thus may provide a large amount of background information to the user and conversation in a computationally-efficient and memory-efficient manner, enabling improved conversational memory without sacrificing response time or requiring unduly increased storage resources.

The method 200 may further include, at block 214, generating and outputting a response to the user in response to the user input. Block 214 may include, for example, formatting the output of the LLM in a form responsive to the user input (e.g., as a chatbot response, as a search result, etc.).

FIG. 3 is a block diagram illustrating example functionality of the data storage management module 124, as it may be used to manage long-term memory and short-term memory in connection with LLM conversational memory.

The data storage management module 124 may perform one or more security and access control functions 302, in some embodiments. For example, the data storage management module 124 may append data privacy and permission information to each stored piece of data. For example, the data storage management module 124 may add (and update, as necessary) a privacy level (e.g., privacy setting) to each stored piece of data that indicates who may access that information and whether such information must be anonymized before being input to an LLM, for example. As a result, the data storage management module 124 may review a user's settings (e.g., in a user profile, for example), and append privacy and access information to each stored embeddings vector respective of that user or other information respective of that user before such data is stored and/or before such information is retrieved or passed to an LLM. Data storage, retrieval, and/or output functions described herein may pass through the security and access control 302.

The privacy level may include a user-selected privacy setting. The privacy setting may include, for example, one or more of an anonymization preference, a data retention preference, or a data deletion preference. Each of the anonymization preference, the data retention preference, and the data deletion preference may include one or more preferences specific to one or more types of data. For example, the user may provide different preferences for records of items that the user interacts with, for personally-identifiable information (PII), for purchases made by the user, and so on. The anonymization preference may include the user's preference for whether or not the user's data can be directly input into automated systems, such as LLMs. The data retention preference may include whether or not the particular type of data can be stored by the system. The data deletion preference may include a maximum retention period, a maximum volume of data, etc. respective of the user that the system may retain before deleting that data.

As noted above, a privacy setting may be stored in a user profile. The user may provide privacy setting information when editing the user's profile, in some embodiments. Additionally or alternatively, the LLM facilitation system 106 may prompt the user to provide privacy setting information before, during, or after the user's first interaction with the LLM 108.

The data storage management module 124 may include a memory dispatch module 304 that determines a type of data to be stored and, based on the type, stores in the appropriate location and format. For example, the memory dispatch module 304 may determine whether data is unstructured data, structured data, or an embeddings vector, and store data appropriately, as described below. For example, based on the determined type of data, the data storage management module 124 may invoke an appropriate one of a vector database interface 306, a structured database interface 308, or a file storage interface 310.

Each of the storage interfaces 306, 308, 310 may interact with a respective storage medium (e.g., a respective portion of short-term data storage and/or long-term data storage) and read and write data in the appropriate fashion. That is, the vector database interface 306 may cause a data storage medium to index an embeddings vector and store it in conjunction with relevant metadata, such as a session identifier, user identifier, etc. The structured database interface 308 may determine an appropriate structure for a piece of data and cause a data storage medium to index the structured piece of data in the determined structure. The unstructured database interface 310 may cause a data storage medium to index and store unstructured data, including adding any limiting information to the unstructured data (e.g., indicating the beginning and/or end of an unstructured piece of data). Like the vector database interface 306, the structured database interface 308 and unstructured database interface 310 may cause data to be stored in conjunction with relevant metadata.

The data storage management module 124 may include a memory indexer 312 that indexes the various storage mediums for efficient storage and retrieval, as well as updating indexes as data is added and deleted to maintain efficiency.

The data storage management module 124 may include a memory retrieval module 314 that coordinates data retrieval by the other portions of the LLM facilitation system 106. For example, memory retrieval module 314 may receive data search queries, perform the applicable searches of long-term data and short-term data stores, and return data from all applicable data stores.

The data storage management module 124 may, in some embodiments, delete data from long-term storage and/or short-term storage based on a data deletion setting respective of the user. For example, a user may set a deletion period of ninety (90) days for a particular type of data. The data storage management module 124 may delete data from long-term storage after it has been stored for ninety days, in some embodiments.

FIG. 4 is a flow chart illustrating an example method 400 of session and context management in connection with LLM conversational memory. The method 400, or one or more aspects of the method 400, may be performed by the LLM facilitation system 106, and thus the method 400 may be computer-implemented.

One or more aspects of the method 400 may be performed in response to one or more user inputs, such as a user input received in method 200. Additionally or alternatively, one or more aspects of the method 400 when storing user input or other data (e.g., at the end of a session, or otherwise periodically).

The method 400 may include, at block 402, determining a session and user identity. Block 402 may be performed for each user input to enable retrieval of data related to the input. For example, block 402 may include determining a user identity based on user login information, an IP address, or other metadata associated with the user input. Additionally, block 402 may include determining a session identifier based on, for example, a timestamp associated with the input, the user identity, and an intent, context, and/or one or more entities of the user input (as described above with respect to the method 200). For example, block 402 may include searching session data (e.g., stored in long-term data and/or short-term data) for sessions respective of the same user and within a relatively short amount of time before the current user input and/or in the same context as the current user input, respective of the same user and matching one or more of the same intent or one or more same entities, or some other combination of factors.

The method 400 may further include, at block 404, retrieving and returning data respective of the session determined at block 402 (where an existing session was found). For example, block 404 may include retrieving a summary of the session and one or more of (e.g., a plurality of or all of) the user inputs and system responses in the current session, as described above with respect to the method 200 of FIG. 2.

The method 400 may further include, at block 406, updating short-term memory and long-term memory during and after the session. For example, block 406 may include generating an embeddings vector summary of the session. In some embodiments, such a summary vector may be generated by inputting a prior summary vector and the current user input into a sequence model, such as a recurrent neural network (RNN), a transformer-based model, a convolutional neural network (CNN), and/or another appropriate model type to generate a new summary vector. Additionally or alternatively, generating the summary vector may include inputting all available user inputs and responses to those inputs from the current session into an appropriate algorithm or model, such as Word2Vec, a transformer-based model such as BERT or RoBERTa, and the like.

In some embodiments, block 406 may include generating a multi-session summary. For example, in block 406, one or more summary vectors from one or more previous sessions may be retrieved and input to an appropriate model along with the current user input and/or a summary vector respective of the present session.

In some embodiments, block 406 may further include storing one or more generated session summaries in long-term data storage and/or short-term data storage. For example, block 406 may include storing a current session summary in short-term storage and a multi-session summary in long-term storage, both during an active session.

In addition to generating and storing summaries during a session, block 406 may also include storing one or more of (e.g., each) the user inputs from the current session, and/or the responses provided to the user, in short-term data and/or long-term data. For example, in some embodiments, each user input for a session may be stored in short-term data during a session, and may be moved to long-term data when a session is concluded. Block 406 may include further post-session data handling, in some embodiments. For example, at the end of a session, short-term data other than summaries may be deleted.

The method 400 may further include, at block 408, determining policy compliance of session data. For example, block 408 may include determining whether one or more sessions have expired by comparing the amount of time passed since a last interaction in a session with a predetermined threshold. Such expiry determination may be performed periodically (e.g., hourly, daily) for active sessions stored in short-term data and/or long-term data.

Block 408 may further include determining the compliance of data with privacy policies. For example, before data is stored and/or input to the LLM, block 408 may include removing or anonymizing personally identifiable information (PII). In some embodiments, block 408 may include removing PII from user input immediately upon receipt of that input. Further, block 408 may include referring to the inputting user's preference (e.g., in a user profile) and removing data as needed before storage to comply with those preferences.

Still further, block 408 may include ensuring compliance of data with security policies. For example, block 408 may include encrypting data before storage, including user input, system responses, and summaries.

The method 400 may further include, at block 410, performing and returning session analytics. For example, block 410 may include determining a success rate of system responses to user queries of certain intent, in certain contexts, etc., and returning such success data to a developer user to help further training the system, for example. Additionally or alternatively, block 410 may include compiling a summary of the entities, intents, and contexts of the user's previous sessions and providing such a summary to a live support agent. Additional analytics, and purposes for such analytics, are possible.

FIG. 5 is a flow chart illustrating an example method 500 of user profile management in connection with LLM conversational memory. The method 500, or one or more aspects of the method 500, may be performed by the LLM facilitation system 106, and thus the method 400 may be computer-implemented.

The method 500 may include, at block 502, adding user-provided information to a user profile. Block 502 may include, for example, collecting demographic information about a user, data storage and privacy preference information from the user, and similar information that the user provides explicitly for the purpose of addition to a profile.

The method 500 may further include, at block 504, adding one or more user interactions to the user profile. Such user interactions may include, for example, dates and times of user access to the user interface in connection with which the method 500 is performed, one or more user inputs, one or more system responses to the user inputs, one or more portions of the interface that the user accesses (e.g., webpages, hyperlinks, etc. accessed by the user), communications to or from the user through the interface, and the like. In some embodiments, some user interactions may be stored in the form of an embeddings representation summary. For example, a single embeddings vector representative of all user activity in the user interface may be generated, stored in conjunction with the user profile, and updated periodically (e.g., at the end of each user session).

The method 500 may further include, at block 506, assembling user profile data in order to input the user profile data to an LLM for personalized recommendations. For example, block 506 may include, in response to a user input, retrieving a user summary from the user profile, or retrieving one or more items of user profile data described above and providing the retrieved data for consumption by an LLM or in order to personalize the output before provision to a user.

The method 500 may further include, at block 508, adjusting a user profile according to user interactions with or other user responses to LLM-based personalized responses to the user. For example, a user summary embeddings vector may be updated, the user's preferences may be updated, etc.

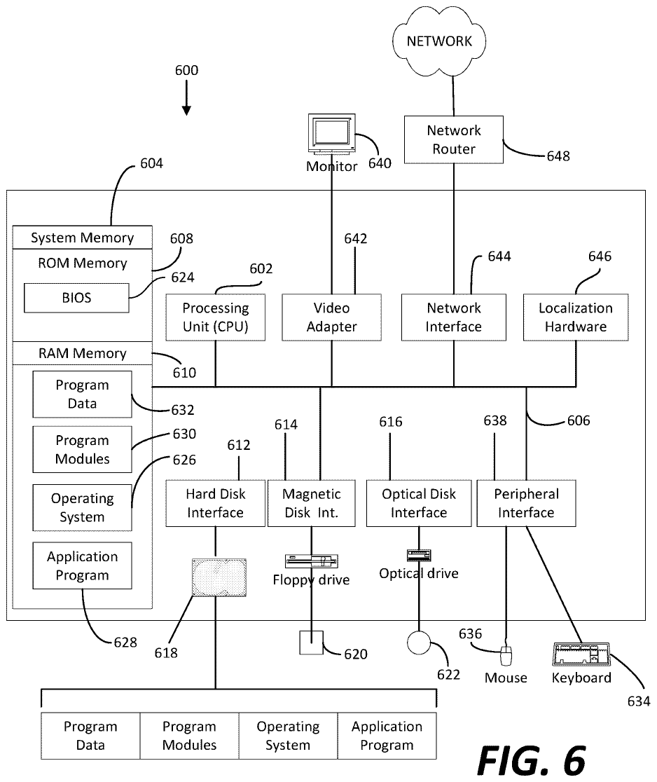

FIG. 6 is a diagrammatic view of an illustrative computing system that includes a computing system environment 600, such as a desktop computer, laptop, smartphone, tablet, or any other such device having the ability to execute instructions, such as those stored within a non-transient, computer-readable medium. Furthermore, while described and illustrated in the context of a single computing system 600, those skilled in the art will also appreciate that the various tasks described hereinafter may be practiced in a distributed environment having multiple computing systems 600 linked via a local or wide-area network in which the executable instructions may be associated with and/or executed by one or more of multiple computing systems 600. The computing system environment 600, or one or more portions of the computing system environment 600, may comprise the LLM facilitation system 106 of FIG. 1, in some embodiments, and/or a user computing device 112.

Computing system environment 600 may include at least one processing unit 602 and at least one memory 604, which may be linked via a bus 606. Depending on the exact configuration and type of computing system environment, memory 604 may be volatile (such as RAM 610), non-volatile (such as ROM 608, flash memory, etc.) or some combination of the two. Computing system environment 600 may have additional features and/or functionality. For example, computing system environment 600 may also include additional storage (removable and/or non-removable) including, but not limited to, magnetic or optical disks, tape drives and/or flash drives. Such additional memory devices may be made accessible to the computing system environment 600 by means of, for example, a hard disk drive interface 612, a magnetic disk drive interface 614, and/or an optical disk drive interface 616. As will be understood, these devices, which would be linked to the system bus 606, respectively, allow for reading from and writing to a hard disk 618, reading from or writing to a removable magnetic disk 620, and/or for reading from or writing to a removable optical disk 622, such as a CD/DVD ROM or other optical media. The drive interfaces and their associated computer-readable media allow for the nonvolatile storage of computer readable instructions, data structures, program modules and other data for the computing system environment 600. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 600.

A number of program modules may be stored in one or more of the memory/media devices. For example, a basic input/output system (BIOS) 624, containing the basic routines that help to transfer information between elements within the computing system environment 600, such as during start-up, may be stored in ROM 608. Similarly, RAM 610, hard drive 618, and/or peripheral memory devices may be used to store computer executable instructions comprising an operating system 626, one or more applications programs 628 (such as one or more applications that execute the methods and processes of this disclosure), other program modules 630, and/or program data 632. Still further, computer-executable instructions may be downloaded to the computing environment 600 as needed, for example, via a network connection.

An end-user may enter commands and information into the computing system environment 600 through input devices such as a keyboard 634 and/or a pointing device 636. While not illustrated, other input devices may include a microphone, a joystick, a game pad, a scanner, etc. These and other input devices would typically be connected to the processing unit 602 by means of a peripheral interface 638 which, in turn, would be coupled to bus 606. Input devices may be directly or indirectly connected to processor 602 via interfaces such as, for example, a parallel port, game port, firewire, or a universal serial bus (USB). To view information from the computing system environment 600, a monitor 640 or other type of display device may also be connected to bus 606 via an interface, such as via video adapter 642. In addition to the monitor 640, the computing system environment 600 may also include other peripheral output devices, not shown, such as speakers and printers.

The computing system environment 600 may also utilize logical connections to one or more computing system environments. Communications between the computing system environment 600 and the remote computing system environment may be exchanged via a further processing device, such a network router 648, that is responsible for network routing. Communications with the network router 648 may be performed via a network interface component 644. Thus, within such a networked environment, e.g., the Internet, World Wide Web, LAN, or other like type of wired or wireless network, it will be appreciated that program modules depicted relative to the computing system environment 600, or portions thereof, may be stored in the memory storage device(s) of the computing system environment 600.

The computing system environment 600 may also include localization hardware 646 for determining a location of the computing system environment 600. In embodiments, the localization hardware 646 may include, for example only, a GPS antenna, an RFID chip or reader, a WiFi antenna, or other computing hardware that may be used to capture or transmit signals that may be used to determine the location of the computing system environment 600.

In a first aspect of the present disclosure, a method is provided that includes receiving, via an electronic user interface, an input from a user, generating a vector representation of the user input, determining a user intent based on the vector representation, retrieving, from a conversational memory store, data respective of a conversational session based on the user intent, determining a user privacy setting associated with the retrieved data, anonymizing the retrieved data based on the user privacy setting, and generating a prompt to a large language model based on the user input and the anonymized data respective of the conversational session.

In an embodiment of the first aspect, determining the user privacy setting includes retrieving the user privacy setting from the conversational memory store.

In an embodiment of the first aspect, the method further includes receiving, from the user, the user privacy setting.

In an embodiment of the first aspect, the data respective of the conversational session includes a plurality of data points, and the method further includes deleting one or more of the data points, after the generating, based on a deletion instruction in the user privacy setting.

In an embodiment of the first aspect, the user privacy setting includes an anonymization preference, a data retention preference, and a data deletion preference.

In an embodiment of the first aspect, the data respective of the conversational session includes a plurality of data points, and each data point is stored in the conversational memory store in association with the user privacy setting.

In an embodiment of the first aspect, the data respective of the conversational session includes a plurality of vectors, each vector representing a previous interaction between the user and the large language model.

In a second aspect of the present disclosure, a system is provided that includes a processor and a non-transitory, computer-readable memory storing instructions that, when executed by the processor, cause the system to receive, via an electronic user interface, an input from a user, generate a vector representation of the user input, determine a user intent based on the vector representation, retrieve, from a conversational memory store, data respective of a conversational session based on the user intent, determine a user privacy setting associated with the retrieved data, anonymize the retrieved data based on the user privacy setting, and generate a prompt to a large language model based on the user input and the anonymized data respective of the conversational session.

In an embodiment of the second aspect, determining the user privacy setting includes retrieving the user privacy setting from the conversational memory store.

In an embodiment of the second aspect, the instructions, when executed by the processor, further cause the system to receive, from the user, the user privacy setting.

In an embodiment of the second aspect, the data respective of the conversational session comprises a plurality of data points, and the instructions, when executed by the processor, further cause the system to delete one or more of the data points, after the generating, based on a deletion instruction in the user privacy setting.

In an embodiment of the second aspect, the user privacy setting includes an anonymization preference, a data retention preference, and a data deletion preference.

In an embodiment of the second aspect, the data respective of the conversational session includes a plurality of data points, and each data point is stored in the conversational memory store in association with the user privacy setting.

In an embodiment of the second aspect, the data respective of the conversational session includes a plurality of vectors, each vector representing a previous interaction between the user and the large language model.

In an embodiment of the second aspect, the system further includes the conversational memory store, wherein the conversational memory store includes a long-term memory store and a short-term memory store, wherein retrieving the data respective of the conversational session based on the user intent includes retrieving data respective of a current session from the short-term memory store, and retrieving a summary of a past session from the long-term memory store.

In a third aspect of the present disclosure, a method is provided that includes storing a plurality of interactions between a user and a large language model (LLM) in a conversational memory store, receiving, from the user, a privacy setting, receiving, via an electronic user interface, an input from the user, determining a user intent of the input, retrieving, from the conversational memory store, data respective of one or more of the plurality of interactions based on the determined user intent, anonymizing the retrieved data based on the privacy setting, and generating a prompt to the large language model based on the user input and the anonymized data respective of the one or more of the plurality of interactions.

In an embodiment of the third aspect, the method further includes generating a summary of a sub-plurality of the interactions and storing the summary, wherein retrieving the data respective of the one or more of the plurality of interactions includes retrieving the summary.

In an embodiment of the third aspect, the user privacy setting includes an anonymization preference, a data retention preference, and a data deletion preference.

In an embodiment of the third aspect, the method further includes deleting one or more of the plurality of interactions from the conversational memory store, after the generating, based on a deletion instruction in the user privacy setting.

In an embodiment of the third aspect, storing the plurality of interactions in the conversational memory store includes storing each interaction of the plurality of interactions in association with the privacy setting.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various embodiments of the present invention.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A method comprising:
receiving, via an electronic user interface, an input from a user;
generating a vector representation of the user input;
determining a user intent based on the vector representation;
retrieving, from a conversational memory store, data respective of a conversational session based on the user intent;
determining a user privacy setting associated with the retrieved data;
anonymizing the retrieved data based on the user privacy setting; and
generating a prompt to a large language model based on the user input and the anonymized data respective of the conversational session.

2. The method of claim 1, wherein:
determining the user privacy setting comprises retrieving the user privacy setting from the conversational memory store.

3. The method of claim 1, further comprising:
receiving, from the user, the user privacy setting.

4. The method of claim 1, wherein:
the data respective of the conversational session comprises a plurality of data points; and
the method further comprises:
deleting one or more of the data points, after the generating, based on a deletion instruction in the user privacy setting.

5. The method of claim 1, wherein the user privacy setting comprises:
an anonymization preference;
a data retention preference; and
a data deletion preference.

6. The method of claim 1, wherein:
the data respective of the conversational session comprises a plurality of data points; and
each data point is stored in the conversational memory store in association with the user privacy setting.

7. The method of claim 1, wherein the data respective of the conversational session comprises a plurality of vectors, each vector representing a previous interaction between the user and the large language model.

8. A system comprising:
a processor; and
a non-transitory, computer-readable memory storing instructions that, when executed by the processor, cause the system to:
receive, via an electronic user interface, an input from a user;
generate a vector representation of the user input;
determine a user intent based on the vector representation;
retrieve, from a conversational memory store, data respective of a conversational session based on the user intent;
determine a user privacy setting associated with the retrieved data;
anonymize the retrieved data based on the user privacy setting; and
generate a prompt to a large language model based on the user input and the anonymized data respective of the conversational session.

9. The system of claim 8, wherein:
determining the user privacy setting comprises retrieving the user privacy setting from the conversational memory store.

10. The system of claim 8, wherein the instructions, when executed by the processor, further cause the system to:
receive, from the user, the user privacy setting.

11. The system of claim 8, wherein:
the data respective of the conversational session comprises a plurality of data points; and
the instructions, when executed by the processor, further cause the system to:
delete one or more of the data points, after the generating, based on a deletion instruction in the user privacy setting.

12. The system of claim 8, wherein the user privacy setting comprises:
an anonymization preference;
a data retention preference; and
a data deletion preference.

13. The system of claim 8, wherein:
the data respective of the conversational session comprises a plurality of data points; and
each data point is stored in the conversational memory store in association with the user
privacy setting.

14. The system of claim 8, wherein the data respective of the conversational session comprises a plurality of vectors, each vector representing a previous interaction between the user and the large language model.

15. The system of claim 8, further comprising:
the conversational memory store, wherein the conversational memory store comprises:
a long-term memory store; and
a short-term memory store;
wherein retrieving the data respective of the conversational session based on the user intent comprises:
retrieving data respective of a current session from the short-term memory store; and
retrieving a summary of a past session from the long-term memory store.

16. A method comprising:
storing a plurality of interactions between a user and a large language model (LLM) in a conversational memory store;
receiving, from the user, a privacy setting;
receiving, via an electronic user interface, an input from the user;
determining a user intent of the input;
retrieving, from the conversational memory store, data respective of one or more of the
plurality of interactions based on the determined user intent;
anonymizing the retrieved data based on the privacy setting; and
generating a prompt to the large language model based on the user input and the anonymized data respective of the one or more of the plurality of interactions.

17. The method of claim 16, further comprising:
generating a summary of a sub-plurality of the interactions and storing the summary;
wherein retrieving the data respective of the one or more of the plurality of interactions comprises retrieving the summary.

18. The method of claim 16, wherein the user privacy setting comprises:
an anonymization preference;
a data retention preference; and
a data deletion preference.

19. The method of claim 16, further comprising:
deleting one or more of the plurality of interactions from the conversational memory store, after the generating, based on a deletion instruction in the user privacy setting.

20. The method of claim 16, wherein storing the plurality of interactions in the conversational memory store comprises storing each interaction of the plurality of interactions in association with the privacy setting.
